(19) United States
(12) Patent Application Publication
(10) Pub. No.: US 2025/0273020 A1
(43) Pub. Date: Aug. 28, 2025

(54) Method and System for Modifying Flight and Drive Parameters of Autonomous Vehicles

(71) Applicant: Vincent Loccisano, Wellesley, MA (US)

(72) Inventor: Vincent Loccisano, Wellesley, MA (US)

(21) Appl. No.: 19/207,637

(22) Filed: May 14, 2025

(51) Int. Cl. G07C 5/02; G01C 21/20

(52) U.S. Cl. CPC G07C 5/02; G01C 21/20

(57) ABSTRACT

The present invention is a system and method for controlling an aviation or road vehicle to optimize performance, where the system can modify flight and drive parameters in real-time to ensure the vehicle can travel from a starting location to a destination location effectively. The system and method monitors and controls parameters of an aircraft or road vehicle and makes calculations that include a baseline-parameter set, a payload-parameter set, and route-parameter set. The system includes sensors coupled with a computer application. The application quantifies each set of data to reach a defined parameter set, further calculating more specific, “critical” parameter sets which recommend an optimized plan to achieve a mission goal. A mission goal might be derived from a critical parameter set.

### TECHNICAL FIELD OF THE INVENTION

This invention relates to autonomous vehicles, particularly drones (Unmanned Aerial Vehicles or UAVs) and autonomous road vehicles. Specifically, the invention relates to a method and system for controlling and modifying flight and drive parameters to proceed in an optimized fashion to achieve a goal.

### BACKGROUND OF THE INVENTION

Navigation systems for conventional, semi-autonomous and autonomous aircraft and land vehicles rely heavily on pre-programmed routes and real-time GPS data to guide them from point A to point B. While these systems excel at basic path-planning, they inadequately address the complex and dynamic operational environments often encountered during a trip. Environmental aspects might be payload weight, vehicle weight, wind speed and other flight conditions; and road conditions, weather, traffic, and energy consumption.

A method and system for controlling and modifying flight and drive parameters would ensure more effective travel based on user defined flight or drive parameters. A more intelligent system would dynamically adjust these parameters to ensure successful missions.

### SUMMARY OF THE INVENTION

A system and method for controlling an aviation or road vehicle in which the system modifies flight or drive parameters in real time to meet a mission goal. The system and method monitors and controls parameters of an aircraft or road vehicle and makes calculations that include a baseline-parameter set, a payload-parameter set, and route-parameter set. The system has sensors coupled with a computer application that quantifies each aforementioned set of data to reach a defined parameter set. It does this by further calculating refined, “critical” parameter sets that recommend an optimized plan to achieve a specific mission goal. A mission goal might be, for example, to prioritize fuel efficiency over time of arrival or vice-versa; or to prioritize fuel remaining upon arrival; or to shorten a trip duration. A mission goal is derived from a critical parameter set. A critical parameter set might have, for example, a desired time of arrival and a desired amount of energy in reserve upon arrival. In a critical parameter set such as this, the application calculates the most energy-efficient route and a departure time that ensures arriving at an appointed time of arrival.

A modern road vehicle has many types of sensors coupled with an on-board processor. The system and method may use a vehicle's on-board processor or a separate processor, such as one in a smartphone or smartwatch. The system and method may use vehicle on-board sensors or may add sensors for additional parameters not measured by the vehicle on-board sensors. Sensors found in a modern vehicle include those that detect stored energy levels, current location, destination coordinates, weather conditions, temperature and other variables. Additional sensors may include wind-speed and temperature sensors as well as weight sensors to measure the payload weight in a vehicle.

In modern aircraft, sensors that work with an on-board processor may be those that detect wind speed, wind shear, actual wind speed and direction, and relative wind speed and direction.

In an example embodiment, the instant system and method calculates parameter sets to optimize performance for at least one of a variety of possible routes of a road vehicle or aircraft. Parameter sets include a baseline-parameter set, a payload-parameter set, and a route-parameter set. A critical parameter is a specific parameter distilled from the above parameter sets. It is considered the most important parameter to the mission goal, and therefore is critical in calculating optimal parameters so that a desired mission goal may be met. In an example embodiment, efficient energy usage may be the mission goal. In another example, a mission goal might center on the amount of stored energy remaining upon arrival at a destination. Other mission goals prioritize arrival time, trip duration, or other aspects. From the calculated parameters, a preferred trip and route may be chosen to achieve the mission goal.

A baseline-parameter set includes vehicle, boat or aircraft weight, energy-storage capacity, amount of stored energy, and energy-conversion efficiency.

A payload-parameter set includes payload weight, center of gravity and volume of the payload.

A route-parameter set includes origin and destination, as well as the distance between the two; change in altitude and optimal altitude; change in elevation; energy requirements; operating speed; speed limits; traffic density; and traffic lights. These factors are considered along with calculations factoring in alternate routes, time of departure, time of arrival, weather conditions, wind speed, wind direction, temperature, and routing options between origin and destination.

Vehicle, boat or aircraft weight includes total weight on departure and changes in that weight over the course of the trip. For example, an aircraft or vehicle with an internal-combustion engine may depart with a full tank of fuel which reduces in weight over the course of the trip; or passengers may be picked up or dropped off along the route.

Energy-storage capacity refers to the battery capacity in an electric vehicle, or the amount of fuel an internal-combustion vehicle can hold. The amount of stored energy is the charge level of a battery bank or the amount of fuel in the fuel tank.

Energy-conversion efficiency measures the miles per gallon of fuel or the miles per volt of charge required to move a vehicle. The efficiency is calculated to determine the total energy required to move the loaded vehicle from origin to destination. An amount of energy likely remaining upon arrival at the destination may be designated a critical factor, or the amount of stored energy may trigger a recommendation to add fuel or charge prior to departure, or to travel with as little fuel as possible to reduce weight in order to increase efficiency.

In one example, a battery at 80% charge is a factor in calculating an optimal route plan. A different calculation would factor in a vehicle's potential energy, e.g., a vehicle charged to 100% prior to departure, or a filled gas tank. One skilled in the art understands that a full tank would raise vehicle weight, requiring a calculation loop for each change in tank weight. The system and method's calculations account for this with a weighting method that shows tradeoffs between a vehicle's weight at departure vs. momentum gained from added fuel.

Payload and/or aircraft/boat/vehicle weight information may come from the vehicle's manufacturer. Payload might be provided by a manufacturer for an example pallet of goods; or a scale or forklift at a departure location may also be used in determining payload. In some examples a driver may partially deliver or amend a payload along the course of a trip. When loading an aircraft, it may be important to calculate a payload center of gravity. Payload volume may be a known quantity, as with a standard pallet size or container size, or may be measured at the time of departure.

Origin and destination, and the distance between the two, are defined as a straight-line measurement or the distance through turns, over hills, over roads of a particular route, or various possible routes. Measuring the distance to the destination for aircraft may involve a flight over a “great circle” route or flight over rhumb lines. Flight distance might involve deviation from a direct route due to controlled airspace, restricted airspace or instructions from air-traffic control. Other considerations for aircraft include deviation under adverse weather conditions. Small aircraft might consider terrain obstacles.

When used with aircraft, the system and method measures altitude changes; when used with land vehicles, the system and method measures changes in elevation. A flight plan requiring a higher-than-normal altitude to avoid terrain or adverse weather may affect energy consumption. For land vehicles, factors such as a heavy load brought over a great change in elevation may affect energy consumption or travel time.

Determining aircraft altitude may involve adhering to minimum safe altitude, airspace restrictions or direction of flight, or changes in altitude along the route to accommodate terrain or severe weather. Determining optimal altitude may involve factors including the service ceiling of the aircraft; climb-performance weather conditions; terrain obstacles; turbulence; cloud-cover and icing; and fuel efficiency when climbing with substantial payload weight.

Aircraft instrumentation measures wind speed and wind direction. Land-based vehicles obtain this information from measurement towers along the way, or by on-board anemometers.

Aircraft weight is determined by factoring its known weight (provided by manufacturer) plus the weight of added features or equipment. Fuel weight may be calculated by the amount of fuel required for the trip; the reserve required upon arrival; and in some cases, the vehicle's energy efficiency. Aircraft may reduce weight and increase flight efficiency by flying with a minimum safe volume of fuel.

Measuring temperature and determining weather conditions may involve National Weather Service data in combination with on-board sensors in the aircraft or information from applications that use crowd-sourced data.

Energy requirements for each trip may be calculated by a combination of parameters such as payload weight, distance, speed, and vehicle efficiency.

Determining speed limits may involve calculating a mean speed limit by use of legal speed-limit data; an average speed limit based on the time of day, day of the week, or likely congestion on the road at time of travel; and crowd-sourced average speed data. Together these data points determine operating speed, which is a predicted speed limit that one would be able to maintain over a chosen route at a particular time and day of travel.

The effect of traffic lights on the journey may be calculated by the number of lights on the route and by applying data obtained from: phased traffic-light control; representative traffic data, such as that used in intelligent transport systems (ITS); scenario-based traffic management; open-data inputs, such as those from crowd-sourced apps; and prediction calculations. One skilled in the art is familiar with these methods of automated traffic-light-control data.

Traffic density may include the calculation of an average density based on time of day, day of week, or that of a holiday. Crowd-sourced information, as reported by users of navigation software, is gathered to determine actual traffic speed, congested areas, obstacles, accidents, and other information.

Parameters may be adjusted to accommodate a specific time of arrival or a specific duration of a trip.

Weather conditions include the effect of wind speed and direction on fuel economy. For land, water and air vehicles, it is understood that a headwind may negatively affect energy consumption and a tailwind may beneficially affect it.

Routing options may be determined by running various scenarios based on available routes and environmental conditions, as well as user input, to recommend changes for reaching a destination. Recommended changes might be based on user-defined objectives such as specific arrival time, specific travel time, fuel efficiency, weather conditions and the like. These recommendations might be to charge or fuel the vehicle prior to departure; to refuel or recharge along the way; to take an alternative route; change speed, or change a departure time to meet a user-provided preference in the determined environment with the given vehicle.

Vehicle on-board sensors are equipped to determine most of the above parameters. In some embodiments, sensors are added to determine, for example, wind speed and direction, as well as payload weight. This type of data can come from the vehicle itself, or from data sources at the departure location or along the route. For example, wind speed can come from measurement towers along the way. Payload can come from the forklift that was used in loading the item, or from a scale in the shipping hub. In other embodiments, data is gathered from data sources along the route or at a departure location and factored into parameter sets. For example, crowd-sourced information may inform some parameters.

In one example, a critical parameter set may be one of available energy. In this example, the optimal route may be one through which an aircraft flies slowly to conserve energy as it delivers its payload. In another example, a critical parameter might be a set that prioritizes available energy at time of arrival. In that example, a route is calculated in which the pilot may be able to fly slowly given a specific departure time.

In another example, payload weight, energy use, and remaining energy at destination may together be considered a critical parameter set (for example, the need to reach a destination with a particular payload, using a predetermined amount of energy, culminating with fuel in reserve at destination). Estimated energy use may be defined as, for example, a combustion-engine vehicle's miles-per-gallon rating, (or “efficiency rating”) carrying a specific payload weight, over the distance of the preferred route. The remaining energy at trip completion may be calculated by the available energy minus the energy required to move the payload weight over the distance of the preferred route.

In another example, a baseline parameter, payload parameter and route parameter may be calculated to determine the most accurate estimated energy usage.

Parameters specific to road vehicles include distance, traffic density, traffic lights, speed limits, vehicle weight, payload weight, change in elevation, wind speed and direction, and weather. Parameters specific to aircraft include distance, altitude and optimal altitude, wind speed and direction, temperature, weather, aircraft weight, and payload weight. Parameters of consideration to road vehicles and aircraft include energy storage capacity and energy-conversion efficiency.

In an example iteration, the application calculates the amount of energy required to overcome the combined parameters; factors in the efficiency of the vehicle; and produces a result that determines the total energy required for the journey.

In some embodiments, the application compares the total energy required for the journey to the amount of energy stored in the vehicle, and further calculates changes in parameters required to reach the destination. For road vehicles these might be changes in speed or lane selection; for aircraft these might be changes in altitude, speed and direction. Other recommendations may include those for changing departure time; charging or fueling prior to departure; planning to charge or refuel along a journey; and traveling at night to avoid traffic.

The system and method optimizes a vehicle's performance by defining a baseline vehicle parameter set which includes vehicle weight, energy-storage capacity, and energy-conversion efficiency. It defines a payload-parameter set, which includes payload weight, payload center of gravity, or payload volume. It determines a route-parameter set, including origin and destination, altitude change, operating speed, time of departure, time of arrival, weather conditions, and potential routing options between origin and destination. It defines at least one critical parameter from the above vehicle parameters, payload parameters and/or route-parameter sets. Finally, it calculates a preferred route which addresses the requisite critical parameter. For example, if the critical parameter is available energy, the system and method picks a route where a pilot may fly slowly to deliver a payload. An alternative would be a critical parameter of available energy together with time of arrival, where one might still fly slowly but now have a definitive departure time.

In another example embodiment the method may optimize

One skilled in the art understands that the term ‘vehicle’ may refer to an aircraft, boat, car or truck; although specific terms may be used for clarity.

### BRIEF DESCRIPTION OF DRAWINGS

FIG. 1 is a diagram of an example embodiment of the disclosure.

FIG. 2 is a diagram of an iteration of the embodiment.

FIG. 3 is a diagram of an iteration of the embodiment.

### DETAILED DESCRIPTION OF THE INVENTION

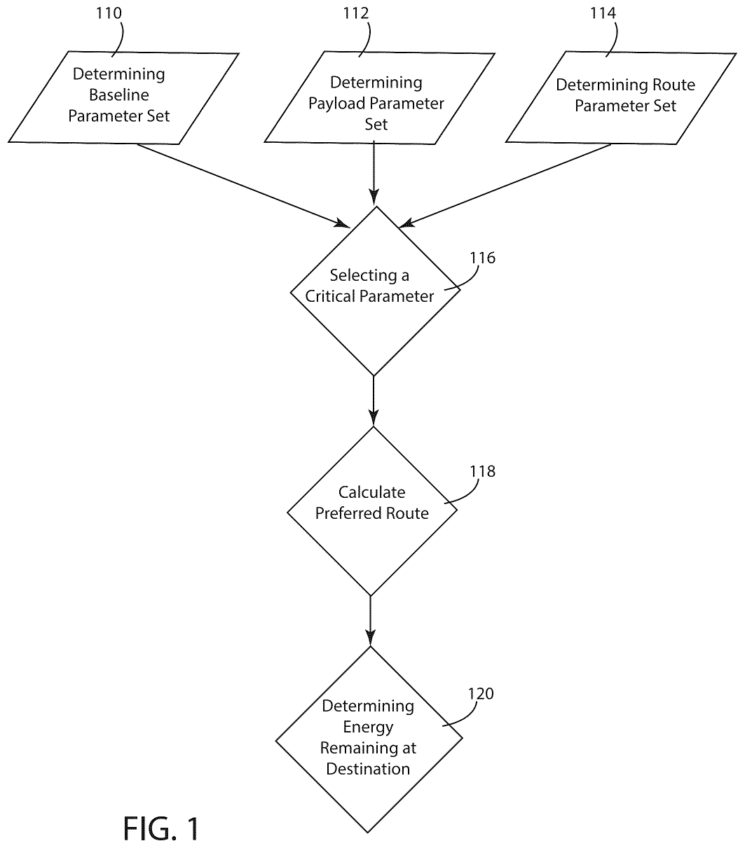

The diagram of FIG. 1 shows a method for controlling a vehicle to determine energy remaining upon arrival at a destination, in consideration of parameters required to reach the destination. An example embodiment applies to road vehicles by measuring inputs and using a computer application to determine parameters. The method begins by determining a baseline-parameter set 110 for a vehicle, which accounts for the vehicle's weight, energy-storage capacity and energy-conversion efficiency. The method continues by determining a payload-parameter set 112 that accounts for payload weight, center of gravity, vehicle size and change in elevation along the route. The method further continues by determining a route-parameter set 114 that accounts for origin and destination, operating speed, time of departure, time of arrival, weather conditions, wind speed, wind direction, traffic lights along the route, speed limits, and all possible rerouting options between origin and destination. The method continues by selecting a critical parameter 116 from the baseline-parameter set, payload-parameter set, and route-parameter set.

A critical parameter is a parameter chosen to determine the successful outcome of the journey or mission. The method determines or measures each parameter, quantifies each parameter so that an equation may be written to optimize the performance of the vehicle, aircraft or boat to accomplish the journey according to the critical parameter. In order to arrive at the destination and accomplish the critical parameter it may be necessary to alter parameters. The application runs a number of scenarios to determine parameter changes necessary to accomplish the critical parameter over a preferred route.

In one example, the critical parameter may be the parameter likely to require the least amount of energy along the journey. The method continues by calculating a preferred route 118 based on the critical parameter, weighed against the possible routes to determine the plan and route that will likely achieve the mission goal. The method culminates by determining energy remaining at the destination 120. The remaining-energy calculation also determines the amount of energy required to arrive at the destination according to the critical parameter and known factors related to vehicle efficiency, such as manufacturers information, or efficiency calculated over time by on-board sensors.

Vehicle on-board sensors are equipped to determine most of the parameters. In some embodiments, sensors are added to determine, for example, wind speed and direction, and payload weight. With parameters measured and determined, an application calculates the energy required to drive the distance to the destination. Vehicle efficiency is calculated to determine the total energy required to move the loaded vehicle from the current location to the destination. The total energy required is compared to the amount of stored energy in the vehicle, and the result calculates a preferred route 118 for reaching the destination, as well as the amount of energy likely remaining upon arrival 120. In addition to a preferred route, the application might recommend charging or fueling the vehicle before departure; refueling or recharging along the way; taking an alternative route; changing speed, or changing a departure time.

Another example embodiment applies to aircraft by similarly measuring inputs and using a computer application to determine parameters. The method begins by determining a baseline-parameter set 110 for an aircraft which accounts for the aircraft's weight, energy-storage capacity and energy-conversion efficiency.

The method continues by determining a payload-parameter set 112 that accounts for payload weight, center of gravity, aircraft size and change in altitudes along the route. The method further continues by determining a route-parameter set 114 that accounts for origin and destination, operating speed, time of departure, time of arrival, weather conditions, wind speed, wind direction, and all possible rerouting options between origin and destination.

The method continues by selecting a critical parameter 116 from the baseline-parameter set, payload-parameter set, and route-parameter set. In this instance, a critical parameter is one selected to have the greatest effect on the successful outcome of the mission over the course of the journey. The method continues by calculating a preferred route 118 based on the critical parameter set considered against possible routes to determine the route that achieves the mission goal. An example mission goal might be to carry a payload to a destination along a route that is updated with real-time data. The method culminates by determining energy remaining at destination 120. The remaining-energy calculation also determines the amount of energy required to arrive at the destination according to the critical parameter set and known vehicle-efficiency factors, such as manufacturer's engine-efficiency rating, or results from an average-efficiency factor derived from an on-board sensor that measures miles per volt or miles per gallon.

Aircraft on-board sensors are equipped to determine most of the parameters. In some embodiments, sensors are added to determine, for example, payload weight, weather, and optimal altitude. With these parameters measured and determined, an application calculates the energy required to fly to a destination. Aircraft efficiency is calculated to determine the total energy required to fly from the current location to the destination. The total energy required is compared to the amount of stored energy in the aircraft, and the computer application calculates a preferred route for reaching a destination, as well as the amount of energy likely remaining upon arrival. A preferred route might involve recommendations to charge or fuel the aircraft prior to departure; to stop to refuel or recharge along the way; to take an alternative route; to change speed; to change traveling altitude, or to change a departure time.

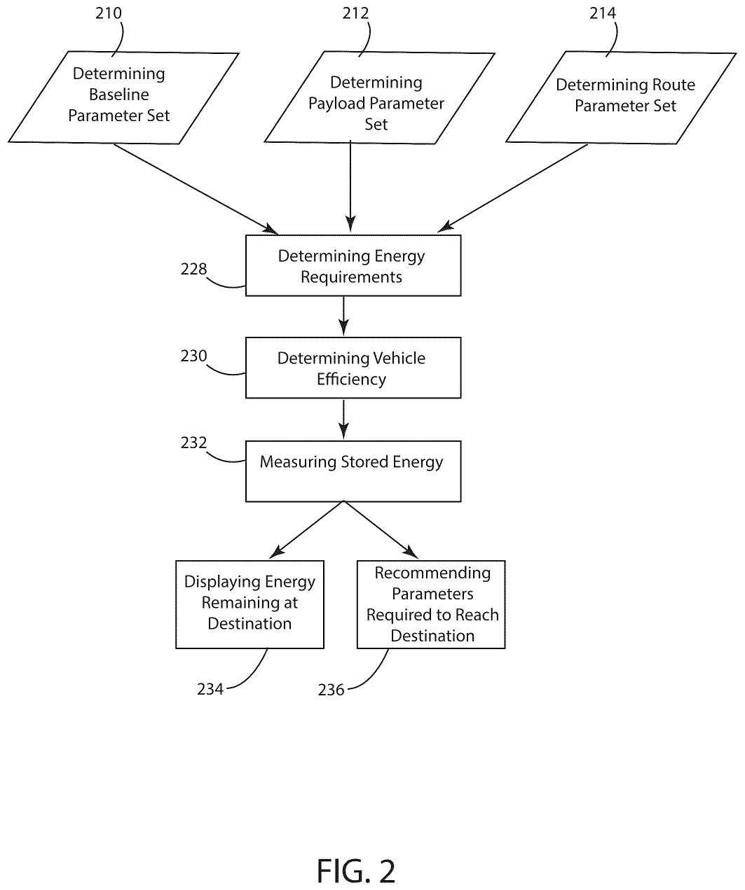

The diagram of FIG. 2 shows an example wherein a critical parameter set is chosen and an outcome determined. In this case, the critical parameter is a method for controlling a road vehicle to determine energy remaining upon arrival at a destination, and recommending parameters required to reach the destination.

In the example embodiment, the method begins by gathering data used to determine a baseline parameter set 210. Then it determines a payload parameter set 212 and continues by determining a route-parameter set 214.

A baseline-parameter set includes vehicle weight, energy-storage capacity, amount of stored energy, and energy-conversion efficiency.

A payload-parameter set includes payload weight, center of gravity and volume of the payload.

A route-parameter set includes origin and destination and the distance between the two, as well as change in altitude, change in elevation, energy requirements, operating speed, speed limits traffic density and traffic lights, for each possible route, time of departure, time of arrival, weather conditions and routing options between origin and destination.

In this example the critical parameters chosen include determining energy requirements 228, determining vehicle efficiency and measuring stored energy 232. From these parameters, the system calculates and displays the amount of energy remaining at the destination 234 and the parameters that need to be met to reach the destination.

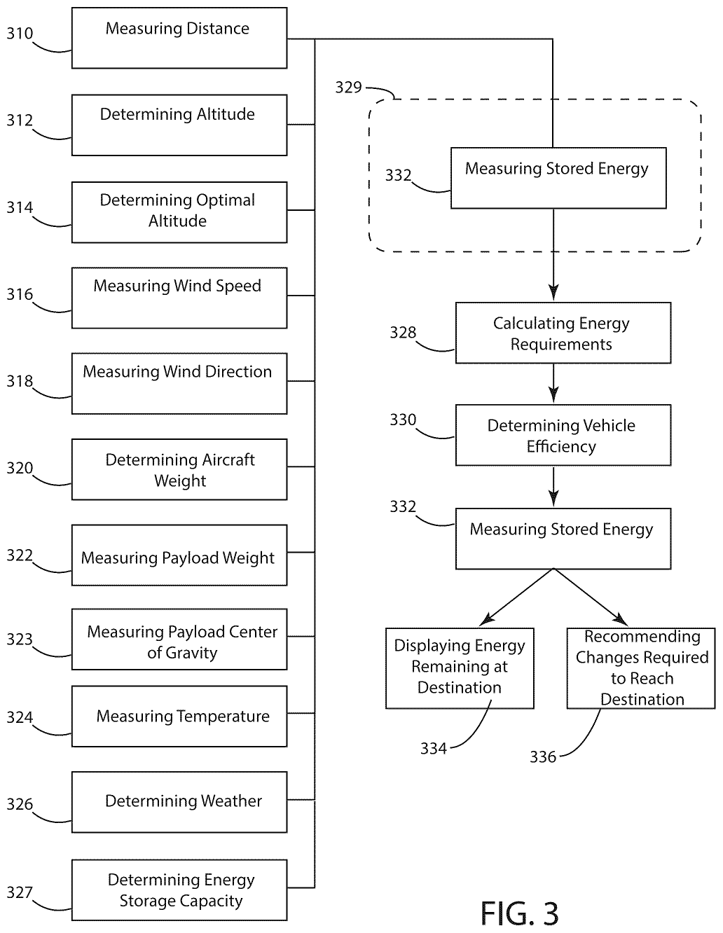

FIG. 3 illustrates an iteration of the embodiment, showing specific parameters. In this example, the parameters are specific to aircraft. The example embodiment measures a combination of basic, payload and route parameters by:

Measuring the distance to the destination 310, which may involve a flight over a “great circle” route or flight over rhumb lines. Flight distance might involve deviation from a direct route due to controlled airspace, restricted airspace or instructions from air-traffic control. Other considerations for aircraft include deviation under adverse weather conditions. Small aircraft might consider terrain.

Determining aircraft altitude 312 may involve adhering to minimum safe altitude, airspace restrictions or direction of flight, or changes in altitude along the route to accommodate terrain or severe weather.

Determining aircraft optimal altitude 314 may involve factors including the service ceiling of the aircraft, climb-performance weather conditions, terrain obstacles, turbulence, cloud cover and icing, and fuel efficiency when climbing with substantial payload weight.

Measuring wind speed 316 and measuring wind direction 318 involve land-based measurements as well as instrumentation on the aircraft.

Determining aircraft weight 320 may involve a known weight by the manufacturer with consideration for added features options or equipment. Fuel weight may involve fuel required for the trip, reserve required upon arrival, and in some cases, energy efficiency. Flying with a minimum safe volume of fuel may reduce weight and increase efficiency.

Measuring payload weight 322 and measuring payload center of gravity 323. Payload center of gravity 323 refers to the placement of the payload in the aircraft required for safe and proper handling.

Measuring temperature 324 and determining weather conditions 326 may involve National Weather Service data in combination with on-board sensors in the aircraft or information from applications using crowd-sourced data.

Measuring energy storage capacity 327 may be determined by a manufacturer's fuel tank size, battery bank voltage or may be adjusted for actual results measured over time. Measuring stored energy 332 may involve collecting data from a fuel gauge or volt meter. Determining vehicle efficiency 330 may involve gathering information from a manufacturer or collecting data from actual performance over time.

Vehicle on-board sensors are equipped to determine most of the parameters. In some embodiments, sensors are added to determine, for example, payload weight, weather, and optimal altitude. Crowd-sourced information may inform some parameters. Payload and/or vehicle weight may be a known factor or may be determined by a scale or forklift at an airport, for example.

With parameters measured and determined, a critical parameter set 329 is chosen by a user. In this example, the critical parameter set is an amount of stored energy at the end of the journey, shown here as parameter measuring stored energy 332. In order to fulfill the goal of having a reserve of energy upon arrival at the destination, the application calculates the energy required 328 to fly the distance to a destination. Aircraft efficiency 330 is determined to calculate total energy required to fly from current location to destination. The total energy required is compared to the amount of stored energy in the aircraft 332 at trip origin. The result of these calculations is an amount of energy likely remaining upon arrival at the destination 334.

Recommended changes in measured and determined parameters are made to optimize performance in order to reach the destination 336 according to the critical parameter.

Recommended parameter changes for reaching the destination 336 might be calculated by the application as it runs scenarios that consider available routes, environmental conditions, and user input.

With an input of a user-defined critical parameter set, the application arrives at recommended trip options and/or alterations. The parameter set defines a preferred mission goal, with criteria such as preferred arrival time, travel time, and fuel efficiency, while accounting for weather conditions, altitude, terrain and the like. Recommended trip options/alterations might be to charge or fuel the aircraft prior to departure; to refuel or recharge along the way; to take an alternative route; or to change speed, altitude, or departure time to meet the user-provided parameters for achieving a mission goal.

1. A method for optimizing vehicle performance comprising:
defining a baseline parameter set; and
defining a payload-parameter set; and
determining a route-parameter set; and
selecting at least one critical parameter from said baseline parameter set, payload parameter set and route-parameter set; and
calculating a preferred route; wherein
parameters are optimized according to the critical parameter over the preferred route.

2. The method of claim 1 wherein:
said baseline-parameter set selected from the group consisting of:
vehicle weight, energy storage capacity and energy conversion efficiency.

3. The method of claim 1 wherein:
said payload-parameter set selected from the group consisting of:
payload weight, center of gravity and volume.

4. The method of claim 1 wherein:
said route-parameter set selected from the group consisting of:
origin and destination, altitude change, operating speed, time of departure, time of arrival, weather conditions and routing options between origin and destination.

5. The method of claim 1 further comprising:
calculating parameter settings necessary to accomplish the at least one critical parameter.

6. The method of claim 2 further comprising:
calculating each baseline-parameter over the preferred route; and
determining and recommending parameter changes for optimizing vehicle performance.

7. The method of claim 3 further comprising:
calculating each payload parameter over the preferred route; and
determining and recommending parameter changes for optimizing vehicle performance.

8. The method of claim 4 further comprising:
calculating each route parameter over the preferred route; and
determining and recommending parameter changes for optimizing vehicle performance.

9. A method for optimizing aircraft performance comprising:
defining a baseline parameter set; and
defining a payload-parameter set; and
determining a route-parameter set; and
defining at least one critical parameter from said baseline parameter set, said payload parameter set and route-parameter set; and
calculating a preferred route; wherein
parameters are optimized according to the critical parameter over the preferred route.

10. The method of claim 9 wherein:
said baseline-parameter set selected from the group consisting of:
aircraft weight, energy storage capacity and energy conversion efficiency.

11. The method of claim 9 wherein:
said payload-parameter set, selected from the group consisting of:
payload weight, center of gravity of payload and volume of payload.

12. The method of claim 9 wherein:
said route-parameter set selected from the group consisting of:
distance between origin and destination, altitude in flight, optimal altitude, operating speed, wind speed, wind direction, temperature, and weather.

13. The method of claim 10 further comprising:
calculating an amount of energy required to fulfill each baseline-parameter over the preferred route; and
determining and recommending parameter changes for optimizing vehicle performance over the preferred route.

14. The method of claim 11 further comprising:
calculating an amount of energy required to fulfill each payload parameter over the preferred route; and
determining and recommending parameter changes for optimizing vehicle performance over the preferred route.

15. The method of claim 12 further comprising:
calculating an amount of energy required to fulfill each route parameter over the preferred route; and
determining and recommending parameter changes for optimizing vehicle performance over the preferred route.

16. The method of claim 9 further comprising:
determining and recommending parameter changes for optimizing aircraft performance to accomplish said critical parameter.

17. A method for optimizing aircraft performance comprising:
selecting at least one critical parameter from the group consisting of:
measuring distance from an origin to a destination, determining altitude maximum and minimum for the aircraft, determining optimal altitude, measuring wind speed, measuring wind direction, determining aircraft weight, measuring payload weight, measuring payload center of gravity, measuring temperature, determining weather, determining energy storage capacity; and
calculating parameter settings necessary to optimize performance to accomplish said critical parameter.

18. The method of claim 17 further comprising:
calculating a preferred route that accommodates said critical parameter.

19. The method of claim 18 further comprising:
calculating an amount of energy required to fulfill the critical parameter over the preferred route; and
determining and recommending parameter changes for optimizing vehicle performance over the preferred route.

20. The method of claim 17 further comprising:
calculating an amount of energy required to fulfill each parameter over the preferred route; and
determining and recommending parameter changes for optimizing vehicle performance to accommodate the preferred parameter over the preferred route.
